(19) United States
(12) Patent Application Publication
(10) Pub. No.: US 2022/0309501 A1
(43) Pub. Date: Sep. 29, 2022

(54) BLOCKCHAIN-BASED TRUSTED TRANSACTION METHOD FOR DATA PRODUCT

(71) Applicants: State Grid Fujian Electric Power Co., Ltd., Fuzhou, Fujian (CN); State Grid Fujian Electric Power Research Institute, Fuzhou, Fujian (CN)

(72) Inventors: Jun Guo, Fuzhou, Fujian (CN); Li Fu, Fuzhou, Fujian (CN); Zhou Zheng, Fuzhou, Fujian (CN); Minglong Zhang, Fuzhou, Fujian (CN); Yuyou Weng, Fuzhou, Fujian (CN); Wei Xie, Fuzhou, Fujian (CN); Chenxiang Lin, Fuzhou, Fujian (CN); Guoqing Lin, Fuzhou, Fujian (CN); Teng Ma, Fuzhou, Fujian (CN); Jianye Huang, Fuzhou, Fujian (CN); Bingqian Liu, Fuzhou, Fujian (CN); Shuang Lin, Fuzhou, Fujian (CN)

(21) Appl. No.: 17/617,578

(22) PCT Filed: Oct. 14, 2021
(86) PCT No.: PCT/CN2021/123669

§ 371 Date: Dec. 8, 2021

(30) Foreign Application Priority Data
Oct. 23, 2020 (CN) 202011150386.6

(51) Int. Cl. G06Q 20/40; H04L 9/00; H04L 9/32; G06Q 20/38

(52) U.S. Cl. CPC G06Q 20/401; H04L 9/50; H04L 9/3247; G06Q 20/3823; G06Q 2220/00

(57) ABSTRACT

The present disclosure relates to a blockchain-based trusted transaction method for a data product, including identity authentication based on a blockchain, creation of an identity code for a data asset, transaction of data, uploading of an enterprise authorization letter to the blockchain, and generation of a data right-confirmation letter. The present disclosure can build a trusted power-system data-transaction platform, help data confirm rights, promote circulation, transaction, and sharing of data, improve data authenticity, and realize efficient, stable, safe and reliable data assetization.

### TECHNICAL FIELD

The present disclosure relates to the field of power-system transaction technologies, in particular to a blockchain-based trusted transaction method for a data product.

### BACKGROUND

State Grid's data operation platforms are classified into internal and external network data operation platforms. Based on the operation concept of Internet e-commerce products, the external network data operation platforms provide “lightweight” functions such as display, transaction, operation, and customer service of data products. The internal network data operation platforms are upgraded and improved based on existing functions, providing “all-round” functions such as data operation and maintenance management as well as construction and operation of data resources and products. The platforms are mainly composed of eight modules: data operation and maintenance management, data product management, data product operation, data tools, data security protection, enterprise data portals, platform system management, and convergence platforms. Moreover, the internal and external network operation platforms are independent from each other.

Currently, the big data center of energies plans to release two products of financial credit and environmental protection on the data operation platforms for operation in a mode of page access and a query made per time. The external network data operation platforms mainly provide data product service for users such as governments, enterprises, residents, and the like, and provide functions such as release, pricing, payment, settlement, and delivery of data products to realize value-added data operation. Based on the data center, the internal network data operation platforms integrate smart cockpits and a variety of data tools to provide data supermarkets as well as capabilities of managing and operating data products for internal business departments, grassroots units, and supporting units. In addition, data of government affairs is accessible through VPN by building a convergence platform.

The external network data operation platforms involve data buyers, data service providers, and data providers. Considering the application objects, application functions, and the like, a safe, efficient, stable and reliable transaction method is required urgently.

### SUMMARY

In view of this, an objective of the present disclosure is to provide a blockchain-based trusted transaction method for a data product. The present disclosure can build a trusted power-system data-transaction platform, help data confirm rights, promote circulation, transaction, and sharing of data, improve data authenticity, and realize efficient, stable, safe and reliable data assetization.

The present disclosure is implemented using the following solution: A blockchain-based trusted transaction method for a data product specifically includes:

identity authentication based on a blockchain: generating a pair of a public key and a private key when an enterprise is registered as a user of an operation platform, and uploading enterprise identity information and the public key to the blockchain, where the public key is used to identify an identity of a user in a system, and the private key is used for digital signing;

creation of an identity code for a data asset: broadcasting, when a data provider releases a product, abstract information of the data asset to determine an ownership of the data asset, creating the identity code for the data asset, and uploading the abstract information and the identity code of the data asset to the blockchain;

transaction of data: completing, by a data buyer, a settlement process in which data is purchased through a payment channel, reaching, by the data buyer and a data provider, a transaction contract, uploading data transaction information to the blockchain, and obtaining, by the data buyer, data call authority;

uploading of an enterprise authorization letter to the blockchain: uploading, by the data buyer, the enterprise authorization letter on the operation platform, and uploading a hash value of the enterprise authorization letter to the blockchain for proof after a data operator approves the enterprise authorization letter; and

generation of a data right-confirmation letter: submitting, by the data buyer, an access request, digitally signing access request information, calling, by the operation platform, the blockchain to verify data access authority, downloading a report or querying a page after the verification is successful, uploading data query result information to the blockchain for proof, and generating the data right-confirmation letter.

Further, the transaction of data further includes an offline transaction mode that is specifically: processing, by the data buyer, order information on the platform after the data buyer and the data provider reach an offline transaction contract and complete payment, uploading the order information to the blockchain, and obtaining, by the data buyer, the data call authority.

Further, a blockchain-based trusted transaction method for a data product further includes transaction tracing query:

querying, by the data provider, transaction information of the data asset by inputting the identity code of the data asset; and

querying, by the data buyer, tracing information of the data asset by inputting the identity code of the data asset.

Further, the abstract information of the data asset includes a summary of the product, a service manner, and a digital signature of the data provider.

Further, the data transaction information includes the identity code of the data asset, data product description, a product delivery mode, a number of times, an amount, the data provider, the data buyer, and a transaction time.

Compared with the related art, the present disclosure has the following advantages. The present disclosure can build a trusted power-system data-transaction platform, help data confirm rights, promote circulation, transaction, and sharing of data, improve data authenticity, and realize efficient, stable, safe and reliable data assetization.

### BRIEF DESCRIPTION OF THE DRAWINGS

FIG. 1 is a schematic flowchart of a method according to an embodiment of the present disclosure (online transaction).

### DETAILED DESCRIPTION

The present disclosure is further described in detail with reference to the accompanying drawings and examples.

It should be noted that the following detailed description is exemplary and is intended to provide further description of the present disclosure. Unless otherwise defined, all technical and scientific terms used herein have the same meaning as commonly understood by one of ordinary skilled in the art to which the present disclosure pertains.

It should be noted that the terms used herein are merely used for describing the specific implementations, but are not intended to limit exemplary implementations of the present application. As used herein, the singular forms are intended to include the plural forms as well, unless the context clearly indicates otherwise, and also, it should be understood that when the terms “include” and/or “including” are used in this specification, they indicate that there are features, steps, operations, devices, elements, and/or combinations thereof.

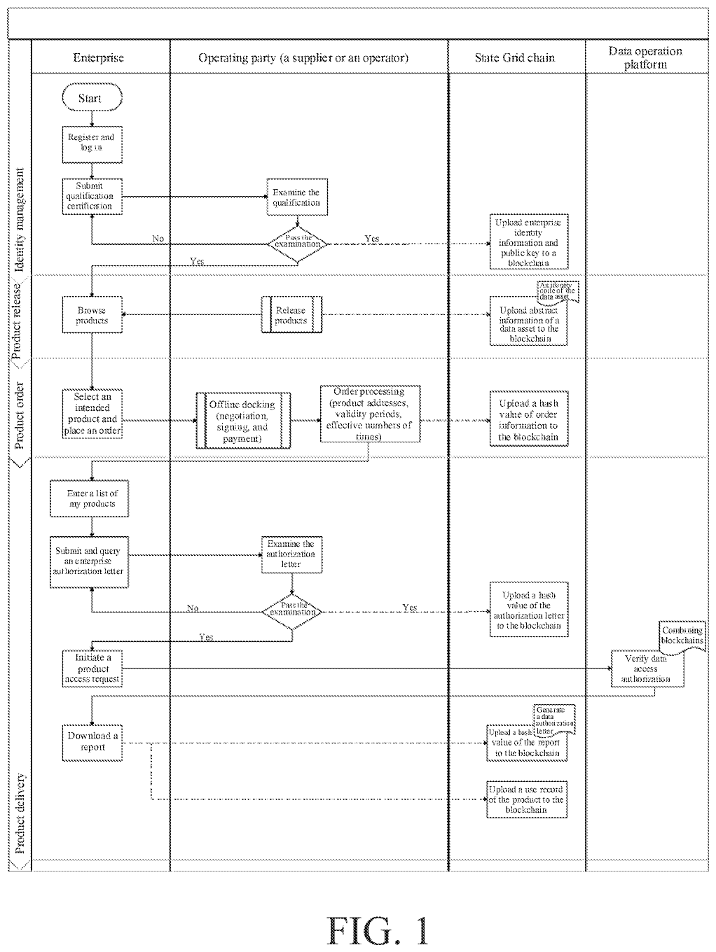

As shown in FIG. 1, this embodiment provides a blockchain-based trusted transaction method for a data product, including a data buyer (an enterprise), a data provider (an operating party, a supplier, or an operator), and a data operation platform. The data buyer and the data provider can both, on the platform, enter data, initiate a request, or accept data. This method specifically includes:

identity authentication based on a blockchain: generating a pair of a public key and a private key when an enterprise is registered as a user of an operation platform, and uploading enterprise identity information and the public key to the blockchain, where the public key is used to identify an identity of a user in a system, and the private key is used for digital signing, so that the authenticity of the user's identity can be ensured, and a recipient of the data can confirm the source of the data and prevent it from being forged;

creation of an identity code for a data asset: broadcasting, when a data provider releases a product (financial credit or environmental protection), abstract information of the data asset to determine an ownership of the data asset, creating the identity code for the data asset, and uploading the abstract information and the identity code of the data asset to the blockchain, to ensure that the identity of the data can be checked and traced;

transaction of data: completing, by a data buyer, a settlement process in which data is purchased through a payment channel, reaching, by the data buyer and a data provider, a transaction contract, uploading data transaction information to the blockchain, and obtaining, by the data buyer, data call authority;

uploading of an enterprise authorization letter to the blockchain: uploading, by the data buyer, the enterprise authorization letter on the operation platform, and uploading a hash value of the enterprise authorization letter to the blockchain for proof after a data operator approves the enterprise authorization letter; and

generation of a data right-confirmation letter: submitting, by the data buyer, an access request, digitally signing access request information, calling, by the operation platform, the blockchain to verify data access authority after the request received by the operation platform is verified valid, downloading a report or querying a page after the verification is successful, uploading data query result information (a data report of hash values, the data provider, the data buyer, a query time, and the like) to the blockchain for proof, and generating the data right-confirmation letter.

In this embodiment, the transaction of data further includes an offline transaction mode that is specifically: maintaining information such as a delivery manner, an effective number of times, and a validity period after the data buyer and the data provider reach an offline transaction contract and complete payment, processing, by the data buyer, order information on the platform, uploading the order information to the blockchain, and obtaining, by the data buyer, the data call authority.

In this embodiment, the blockchain-based trusted transaction method for a data product further includes transaction tracing query. Record information, full-process transaction information, user information of the data asset are acquired. The acquired data is correlated, analyzed, and presented. The source of the data asset is traced and queried, and the transaction information of the data asset is also queried, including the data provider and the data buyer. The transaction tracing query specifically include:

querying, by the data provider, transaction information of the data asset by inputting the identity code of the data asset; and

querying, by the data buyer, tracing information of the data asset by inputting the identity code of the data asset.

In this embodiment, the abstract information of the data asset includes a summary of the product, a service manner, and a digital signature of the data provider.

In this embodiment, the data transaction information includes the identity code of the data asset, data product description, a product delivery mode, a number of times, an amount, the data provider, the data buyer, and a transaction time.

According to the method in this embodiment, considering application objects and functions, the external network data operation platforms are combined with the blockchain technology, to build a trusted data-transaction platform, help data confirm rights, promote circulation, transaction, and sharing of data, improve data authenticity, and realize efficient, stable, safe and reliable data assetization.

The above described are merely preferred embodiments of the present disclosure, which are not intended to limit the present disclosure in other forms. Any person skilled in the art may change or modify the technical content disclosed above into an equivalent. Any simple amendment or equivalent change and modification of the above embodiment made according to the technical essence of the present disclosure without departing from the content of the technical solution of the present disclosure shall fall within the protection scope of the technical solution of the present disclosure.

1. A blockchain-based trusted transaction method for a data product, comprising:
identity authentication based on a blockchain: generating a pair of a public key and a private key when an enterprise is registered as a user of an operation platform, and uploading enterprise identity information and the public key to the blockchain, wherein the public key is used to identify an identity of a user in a system, and the private key is used for digital signing;
creation of an identity code for a data asset: broadcasting, when a data provider releases a product, abstract information of the data asset to determine an ownership of the data asset, creating the identity code for the data asset, and uploading the abstract information and the identity code of the data asset to the blockchain;
transaction of data: completing, by a data buyer, a settlement process in which data is purchased through a payment channel, reaching, by the data buyer and the data provider, a transaction contract, uploading data transaction information to the blockchain, and obtaining, by the data buyer, data call authority;
uploading of an enterprise authorization letter to the blockchain: uploading, by the data buyer, the enterprise authorization letter on the operation platform, and uploading a hash value of the enterprise authorization letter to the blockchain for proof after a data operator approves the enterprise authorization letter; and
generation of a data right-confirmation letter: submitting, by the data buyer, an access request, digitally signing access request information, calling, by the operation platform, the blockchain to verify data access authority, downloading a report or querying a page after the verification is successful, uploading data query result information to the blockchain for proof, and generating the data right-confirmation letter.

2. The blockchain-based trusted transaction method for a data product according to claim 1, wherein the transaction of data further comprises offline transaction, which specifically comprises: processing, by the data buyer, order information on the platform after the data buyer and the data provider reach an offline transaction contract and complete payment, uploading the order information to the blockchain, and obtaining, by the data buyer, the data call authority.

3. The blockchain-based trusted transaction method for a data product according to claim 1, further comprising transaction tracing query:
querying, by the data provider, transaction information of the data asset by inputting the identity code of the data asset; and
querying, by the data buyer, tracing information of the data asset by inputting the identity code of the data asset.

4. The blockchain-based trusted transaction method for a data product according to claim 1, wherein the abstract information of the data asset comprises a summary of the product, a service manner, and a digital signature of the data provider.

5. The blockchain-based trusted transaction method for a data product according to claim 1, wherein the data transaction information comprises the identity code of the data asset, data product description, a product delivery mode, a number of times, an amount, the data provider, the data buyer, and a transaction time.
